(19) United States
(12) Patent Application Publication
(10) Pub. No.: US 2018/0003374 A1
(43) Pub. Date: Jan. 4, 2018

(54) Motion Activated Illumination Device for Use with a Toilet

(71) Applicants: Erin Bulcao, Encinitas, CA (US); Leanna Lyon, Encinitas, CA (US); Nicholas Bulcao, Encinitas, CA (US); Andrew Lyon, Encinitas, CA (US)

(72) Inventors: Erin Bulcao, Encinitas, CA (US); Leanna Lyon, Encinitas, CA (US); Nicholas Bulcao, Encinitas, CA (US); Andrew Lyon, Encinitas, CA (US)

(21) Appl. No.: 15/618,121

(22) Filed: Jun. 9, 2017

Related U.S. Application Data
(63) Continuation-in-part of application No. 14/989,640, filed on Jan. 6, 2016.
(60) Provisional application No. 62/100,353, filed on Jan. 6, 2015.

(51) Int. Cl. F21V 33/00; F21V 23/04; H05B 37/02

(52) U.S. Cl. CPC F21V 33/004; H05B 37/0227; F21V 23/0464; F21V 23/0471; H05B 37/0218

(57) ABSTRACT

A battery powered, motion activated illumination device wherein the illumination device includes an ambient light sensor, a PCB board, a suction mounting system, an integrated battery, an adjustable LED light and a plurality of interchangeable design caps for the LED light.

### RELATED APPLICATIONS

This application is a Continuation-In-Part which claims priority from U.S. patent application Ser. No. 14/989,640 filed on Jan. 6, 2016, which claims priority from U.S. Provisional Application No. 62/100,353, filed on Jan. 6, 2015, the contents of which are hereby incorporated by reference herein.

### FIELD OF THE INVENTION

The present invention pertains generally to illumination devices. More particularly, the present invention pertains to an illumination device for aiding in nighttime bathroom usage. Additionally, the illumination device may aid in toilet training and aiming for children already toilet trained.

Toilet illumination devices and toilet training aids are known in the prior art. The majority of targets for boys are paper or disposable and do not provide a light feature for nighttime use.

In light of the above, it is an object of the present invention to provide the desired features described herein as well as additional advantages of providing an illumination device that is versatile, encourages bathroom use and training and does not require the disassembly of the existing toilet seat in order to use.

### SUMMARY OF THE INVENTION

The present invention is a LED light directed to easing nighttime bathroom use.

It is an object of the present invention to provide an illumination device for assisting in nighttime bathroom usage by an individual as an alternative to turning on bright lights.

It is another object of the present invention to provide an illumination device that is energy efficient by using a motion detector that activates the light once movement is detected.

It is yet another object of the present invention to provide an illumination device for easing the stress of nighttime bathroom usage by an individual having frequent nighttime bathroom usage.

It is an object of the present invention to provide a target for assisting in the toilet training of boys who may require additional practice aiming.

It is another object of the present invention to provide a fun incentive for children to use the bathroom wherein the target is moveable to provide variety and encourage practice.

It is still another object of the present invention to provide an illumination device to assist with reducing the stress and fear of nighttime bathroom use for smaller children.

It is a further object of the present invention to provide a reusable target and/or illumination device for bathroom use wherein the illumination device is hands free and motion detected.

It is further still an object of the present invention to provide an illumination device capable of fitting any toilet.

It is an object of the present invention to provide an illumination device comprised of:
an ornamental front housing;
a rear housing;
a suction cup bracket for attaching the illumination device to a toilet;
a battery pack;
a sensor printed circuit board (PCB);
at least one motion sensor; and
at least one LED bulb.

It is another object of the present invention to provide an illumination device wherein the ornamental front housing is configured in the shape of a star. In a preferred embodiment, the ornamental front housing may be configured in the shape of a moon or heart or any appropriate design that appeals to children.

It is still another object of the present invention to provide an illumination device wherein the front housing and rear housing are manufactured from molded plastic.

It is yet another object of the present invention to provide an illumination device wherein the battery pack provides power for the sensor PCB which in turn controls the at least one motion detector in the sensor behind the sensor lens resulting in the activation of the LED bulb. In a preferred embodiment, the battery pack may provide power for a plurality of LED lights. In a most preferred embodiment, the battery pack may provide power for music, a plurality of LED bulbs of various colors and/or a lighting sequence.

It is still another object of the present invention to provide an illumination device wherein the suction cup bracket may be used to attach the illumination device to a toilet by suction cup (as shown), double sided tape or a plastic hook.

It is a further yet object of the present invention to provide an illumination device wherein the light projection from the lens cover swivels to allow the light to fit a variety of toilets wherein the target may be placed according to user's liking.

It is still another object of the present invention to provide a reusable illumination device wherein the light is activated by movement detected by the at least one sensor making the light hands-free and mess free.

It is yet another object of the present invention to provide an illumination device for aiding in nighttime bathroom usage by an individual. Additionally, the illumination device may aid in toilet training and aiming for children already toilet trained.

It is another object of the present invention to provide a fun incentive for children to use the bathroom wherein the illumination device target is moveable to provide variety and encourage practice.

It is a further object of the present invention to provide an illumination device to assist with reducing the stress and fear of nighttime bathroom use by an individual.

Alternatively, the present invention is an illumination device comprised of:

a shell;

an ambient light sensor;

a PCB board;

a suction system;

an integrated battery; and

an adjustable LED light.

It is a further object of the present invention to provide an illumination device wherein the shell is comprised of an upper housing and a lower housing, the upper housing and the lower housing secured to one another by a snap clip feature.

It is yet a further object of the present invention to provide an illumination device wherein the lower housing of the shell is further comprised of a unique suction system, the unique suction system providing a simple means for mounting the shell of the illumination device to the inside surface of a toilet bowl.

It is still another object of the present invention to provide an illumination device wherein the illumination device is further comprised of an adjustable target switch, wherein movement of the adjustable target switch adjusts the LED light and thereby moves the illumination of the LED light on the surface of the water.

It is a further still object of the present invention to provide an illumination device wherein the LED light is compatible with interchangeable caps, the interchangeable caps having various designs to allow for the changing of the shape of the illumination from the LED light.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIGS. 1a and 1b illustrate the fully assembled device of the present invention;

FIG. 2 illustrates an exploded view of the device of the present invention;

FIGS. 3 illustrates the sensor PCB component of the device of the present invention;

FIGS. 4a and 4b illustrate the rear housing component of the device of the present invention; FIG. 4a shows a front perspective view and FIG. 4b shows a front view;

FIGS. 5a-5c illustrate the internal housing component of the device of the present invention; FIG. 5a shows a front perspective view, FIG. 5b shows a front view and FIG. 5c shows a rear view;

FIGS. 6a and 6b illustrate the Lens/LED bracket component of the device of the present invention; FIG. 6a shows a front perspective view and FIG. 6b shows a rear perspective 6 view;

FIG. 7a-c illustrate the ornamental front housing component of the device of the present invention; FIG. 7a shows a front perspective view, FIG. 7b shows a front view and FIG. 7c shows a rear view;

FIG. 8 illustrates the suction cup bracket component of the device of the present invention;

FIG. 9 illustrates an alternative embodiment of the illumination device of the present invention;

FIG. 10 illustrates the bottom cover of the alternative embodiment of the illumination device of the present invention;

FIG. 11 illustrates the suction mount system of the alternative embodiment of the illumination device of the present invention; and

FIG. 12 illustrates the functioning of the suction mount system of the alternative embodiment of the illumination device of the present invention.

### DETAILED DESCRIPTION OF THE INVENTION

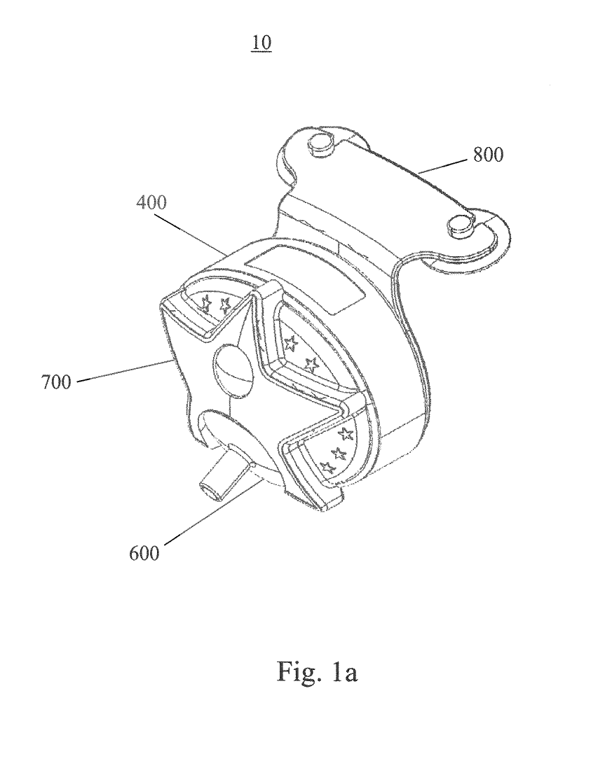

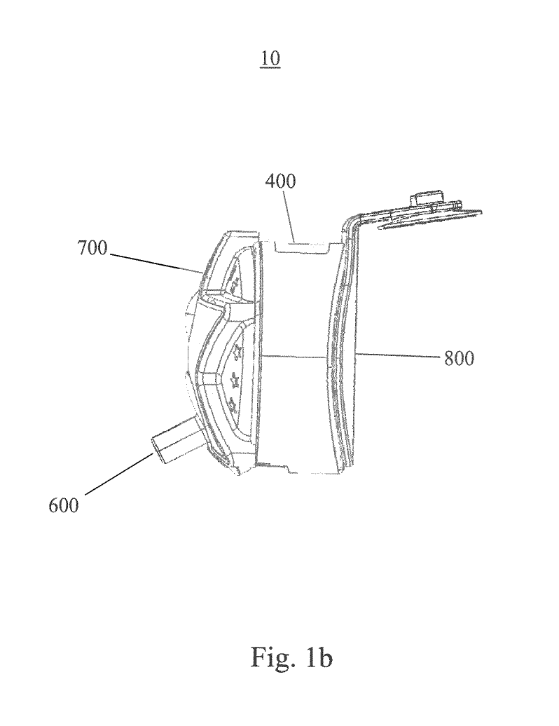

With reference to FIGS. 1a and 1b, shown is a fully assembled illumination device 10 of the present invention. The illumination device 10 as fully assembled includes a rear housing component 400 secured to an ornamental front housing component 700 wherein a Lens/LED bracket component 600 protrudes through an opening in the front housing component 700. A suction cup bracket component 800 is secured to the back of the rear housing component 400.

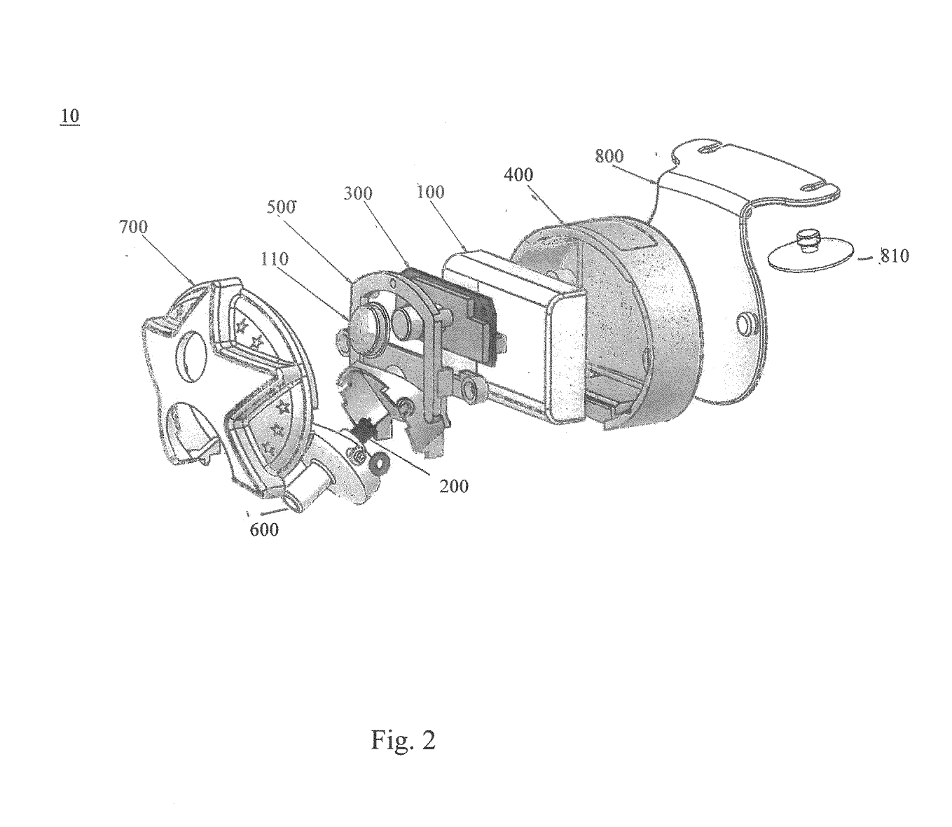

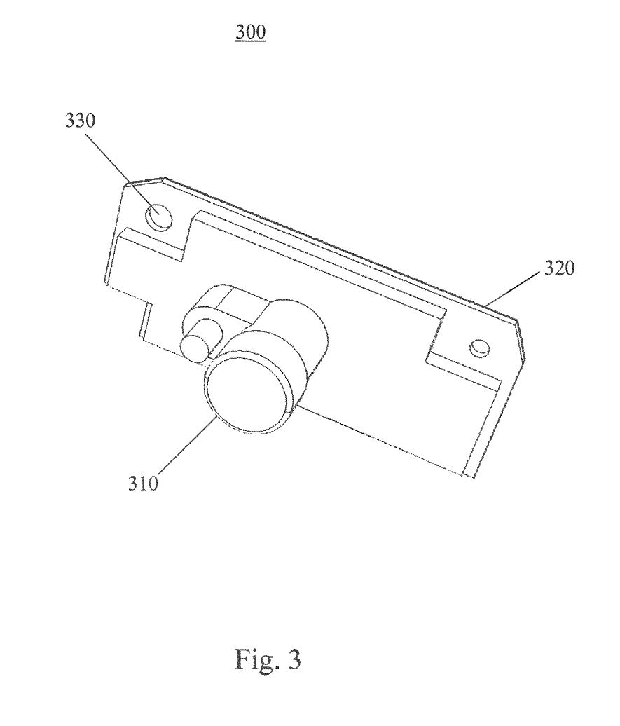

With reference to FIG. 2, shown is an exploded view of the components of the illumination device 10 of the present invention. The device 10 is comprised of an ornamental front housing component 700, a rear housing component 400 and a suction cup bracket component 800. The ornamental front housing component 700 and rear housing component 400 are generally circular in nature. Alternatively, the overall shape of the device 10 may be square, rectangular, triangular or any shape desirable. The ornamental front housing component 700, by way of example only, resembles a large central star with several smaller stars located between the points of the larger star. The ornamental front housing component may resemble any design suitable for the device, including but not limited to, cartoon characters, animals, rainbows, etc. The rear housing component 400 is configured to be secured to the ornamental front housing component 700 such that the components therein are contained in a water tight enclosure. Adjacent to, and enclosed directly therein, the rear housing component 400 is the battery pack component 100. Adjacent to the battery pack component 100 and opposite the rear housing component 400 is the sensor printed circuit board (PCB) component 300 which is integrally connected to battery pack component 100 and thereby converts battery power from battery pack component 100 to operate the movement detecting sensor (as shown clearly in FIG. 3a). Adjacent to the sensor PCB component 300 and opposite the battery pack component 100 is an internal frame component 500 upon which the sensor PCB component 300 and a Lens and LED bracket component 600 are secured on opposite sides thereon. The Lens/LED bracket component 600 is mounted to the internal frame component 500 at a downward angle relative to the internal frame component 500 such that it fits within a circular compartment on the internal frame component 500 with an LED bulb 200 secured to the Lens/LED bracket component 600. Lastly, a sensor lens component 210 fits securely into a cutout in the front housing component 700 such that the motion sensor component (shown in FIG. 3a) may detect movement through the sensor lens component 210.

With reference to FIG. 3, shown is a close-up view of the sensor PCB component 300. As shown, motion sensor 310 is mounted to the front of the sensor PCB component 300 in a centralized position on the sensor PCB component. The board component 320 of the sensor PCB component 300 further includes openings 330 for securing the sensor PCB component 300 to the internal frame component 500.

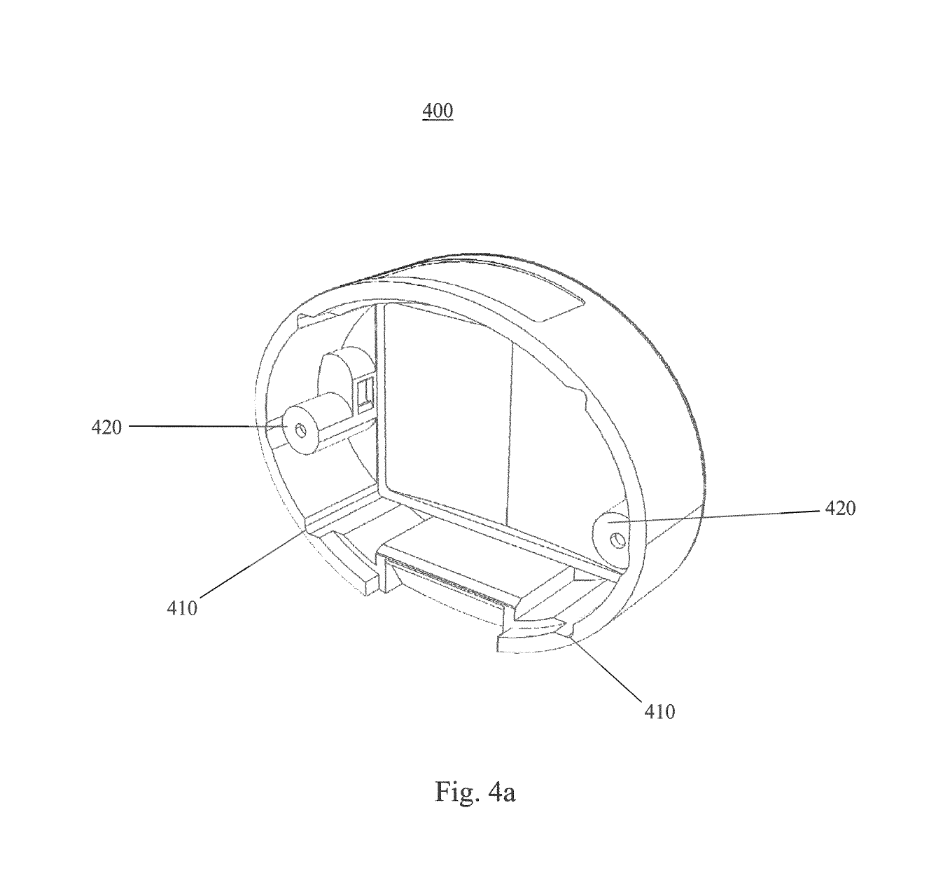

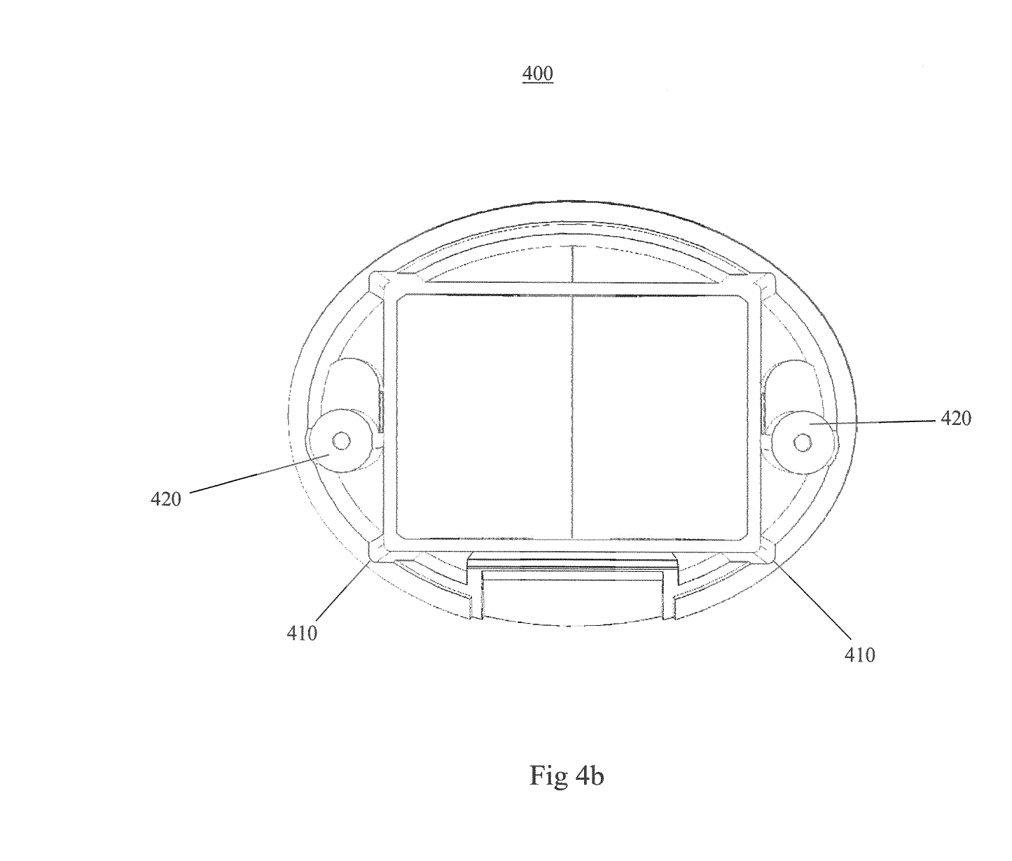

With reference to FIGS. 4a and 4b, shown are close-up views of the rear housing component 400. The rear housing component 400 houses battery pack component 100, sensor PCB component 300 and is securing attached to internal frame component 500 whereby enclosing the electronic components of device 10. By way of example only, in one embodiment, battery pack component 100 contains three AAA batteries, however, battery pack component 100 may contain any suitable battery source for powering device 10. The interior compartment of the rear housing component 400 includes a plurality of notches 410 corresponding to the corners of battery pack component 100 thereby ensuring battery pack component 100 fits tightly and securely within the interior compartment of rear housing component 400. Rear housing component 400 further includes a plurality of openings 420 for securing the internal housing component 500 to the rear housing component 400 by way of a plurality of screws (no shown).

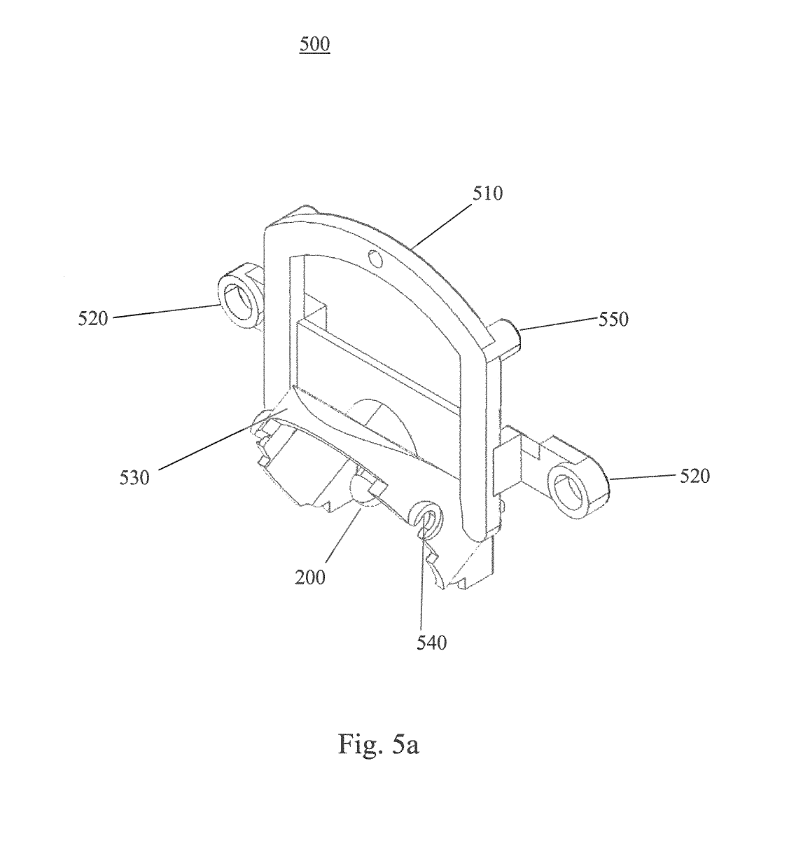

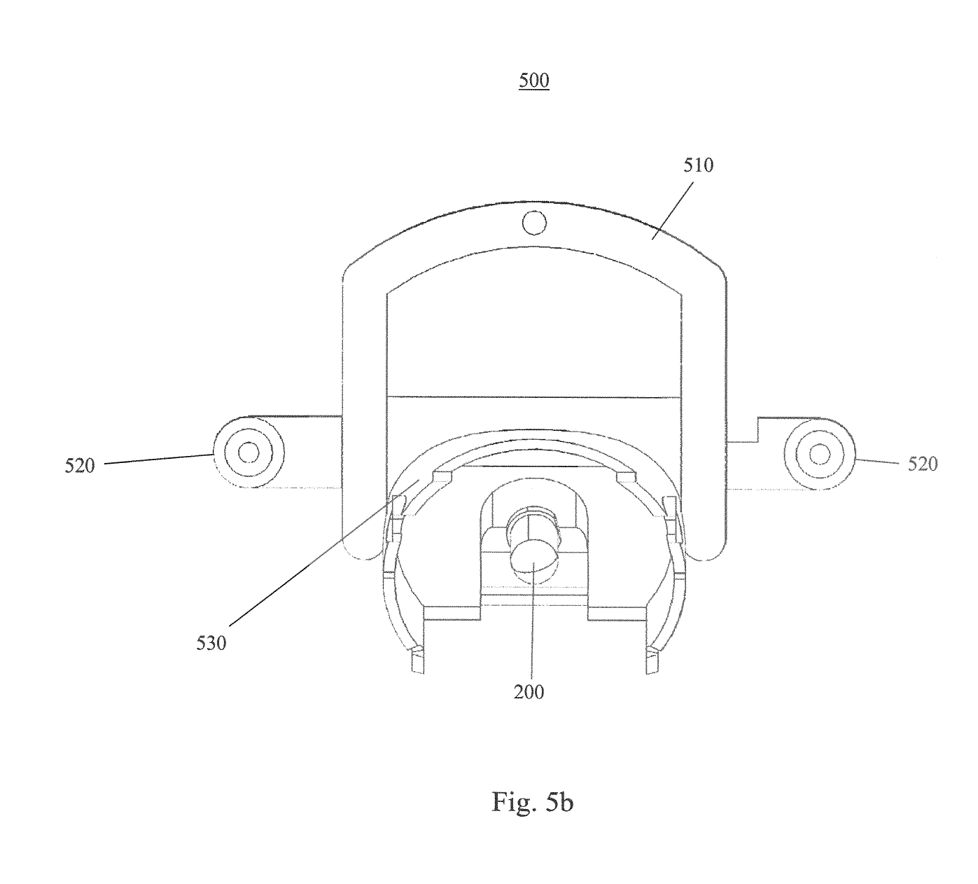

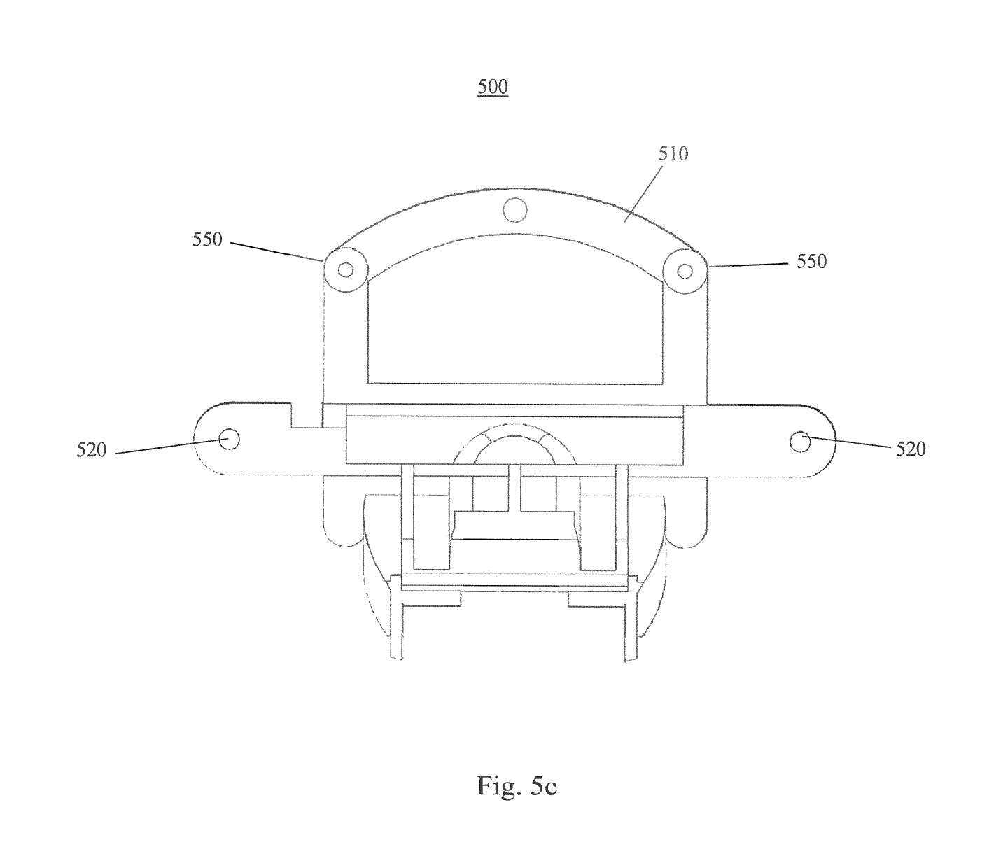

With reference to FIGS. 5a-5c, shown are close-up views of internal frame component 500 wherein the internal frame component 500 securely mounts to the rear housing component 400 by way of screw openings 520 positioned centrally at the right and left sides on the internal frame component 500 and corresponding to the plurality of openings 420 on the rear housing component 400. Toward the top of the right and left sides of the internal frame component 500 are positioned a plurality of screw openings 500 which correspond to the openings 330 in the board component 320 of the sensor PCB component 300 (not shown) such that the sensor PCB component 300 may be securely attached to the internal frame component 500. The position of LED bulb 200 is illustrated in relation to internal frame component 500. Extending from the front of internal frame component 500 is a circular hood component 530 for housing the Lens/LED bracket component 600 (not shown). Notches 540 are shown where Lens/LED bracket component 600 (not shown) is secured to the internal frame component 500 at circular hood component 530. Additionally, the top cross piece 510 of internal housing component 500 is curved to match the curve of rear housing component 400 such that internal housing component 500 rests snuggly within internal housing component 500 when assembled.

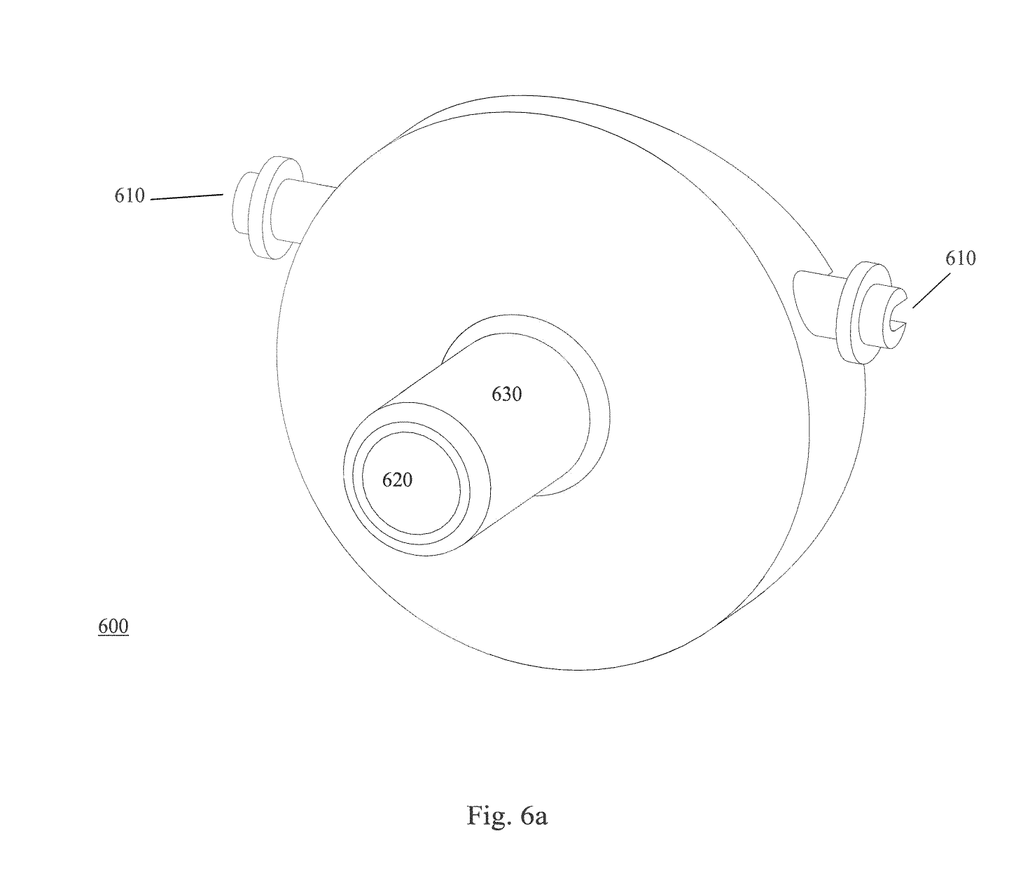

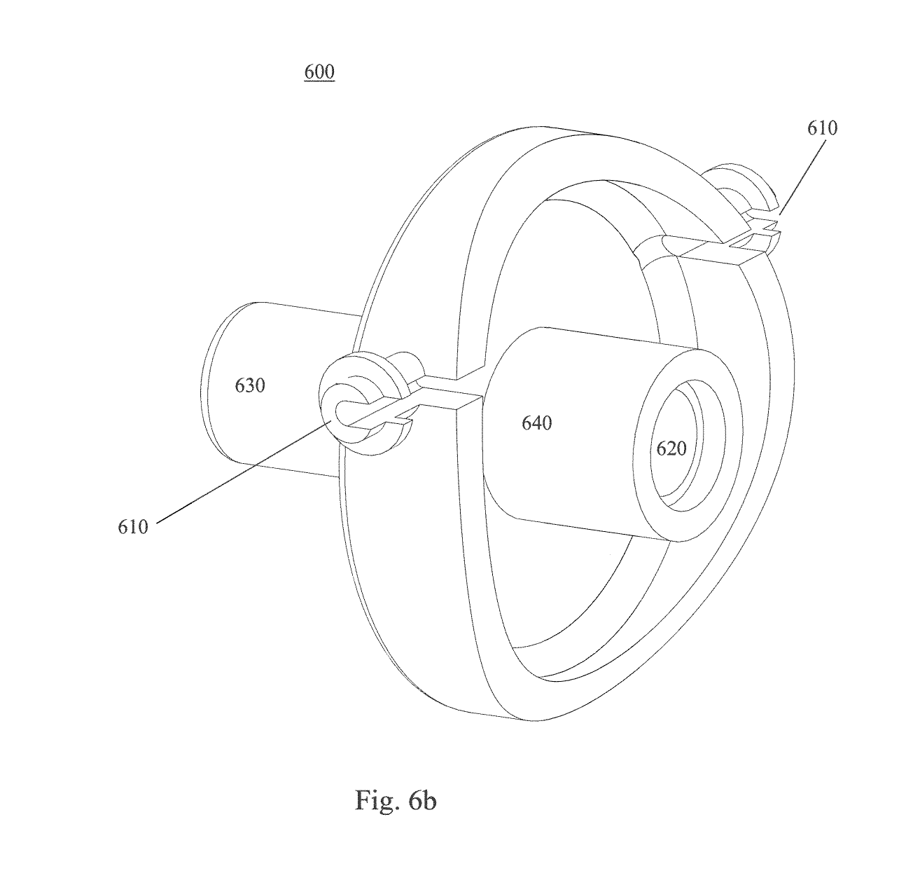

With reference to FIGS. 6a and 6b, shown are close-up views of Lens/LED bracket component 600 wherein a central opening 620 allows for the LED bulb 200 (not shown) to protrude through the Lens/LED bracket component 600. At the right and left sides of the Lens/LED bracket component 600 are a plurality of arm components 610 extending laterally from the right and left sides of Lens/LED bracket component 600. The plurality of arm components 610 correspond to notches 540 (not shown) on circular hood component 530 (not shown) on internal frame component 500. Lens/LED bracket component 600 may rotate or swivel about the plurality of arm components 610 relative to the internal housing component 500.

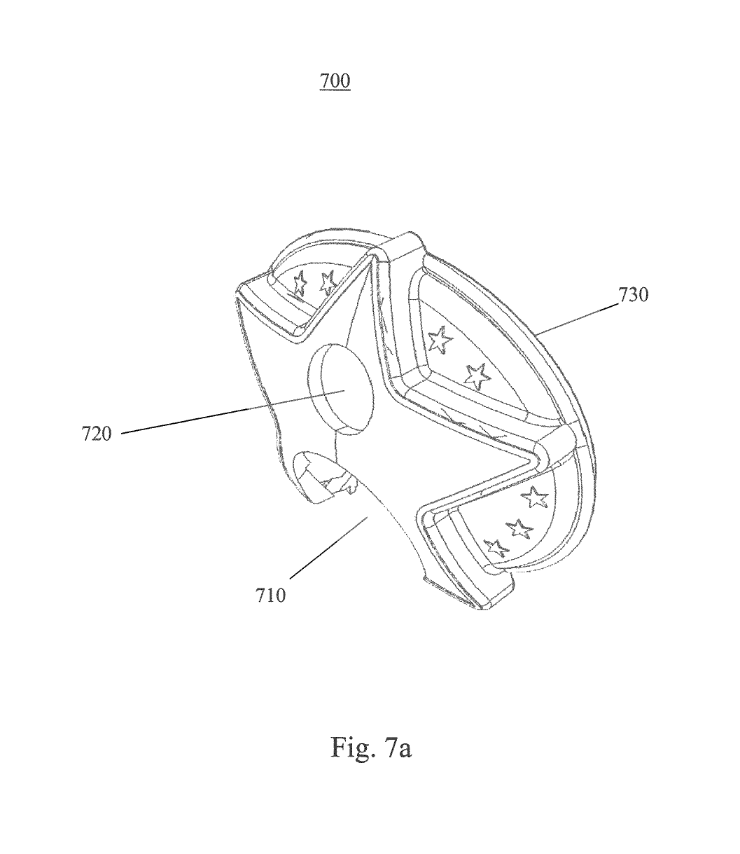

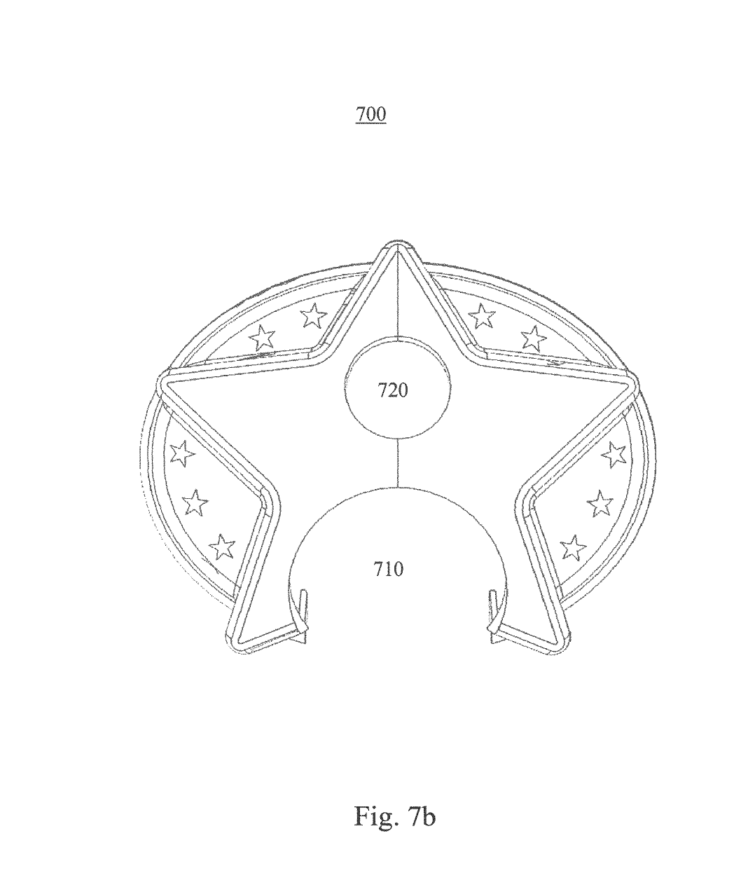

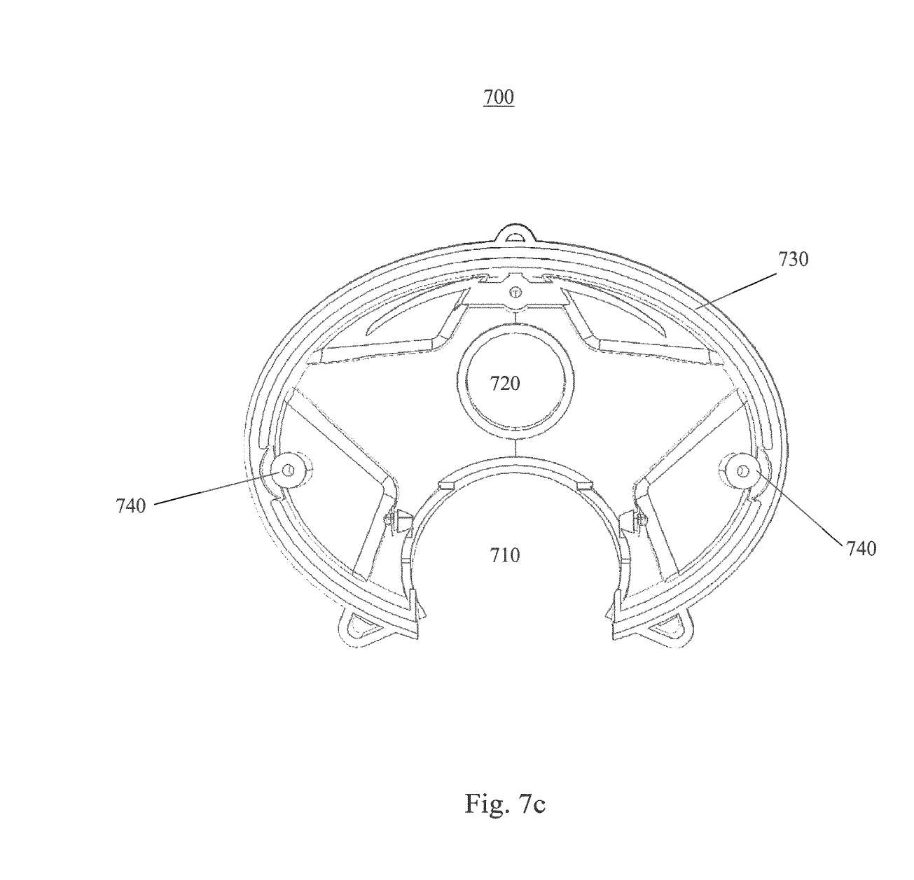

With reference to FIG. 7a-7c, shown is a close-up view of the ornamental front housing component 700 having opening 720 wherein a sensor lens cover (not shown) protects the sensor component 310 from being exposed to the external environment as well as allows the sensor to detect movement in the external environment. The sensor lens cover may be comprised of any transparent material which allows the sensor component 310 to sense movement and thereby activate the illumination device 10. The rear circumference of ornamental front housing component 700 includes a lip 730 that is just smaller in circumference than the circumference of rear housing component 400 (not shown) in order for ornamental housing component 300 to securely snap into rear housing component 400 thereby creating a water tight seal between the ornamental housing component 300 and rear housing component 400 of the assembled illumination device 10. Ornamental housing component 300 may be alternatively secured to internal frame component 500 using screws secured through openings 740 corresponding to openings 520 in internal frame component 500 (not shown).

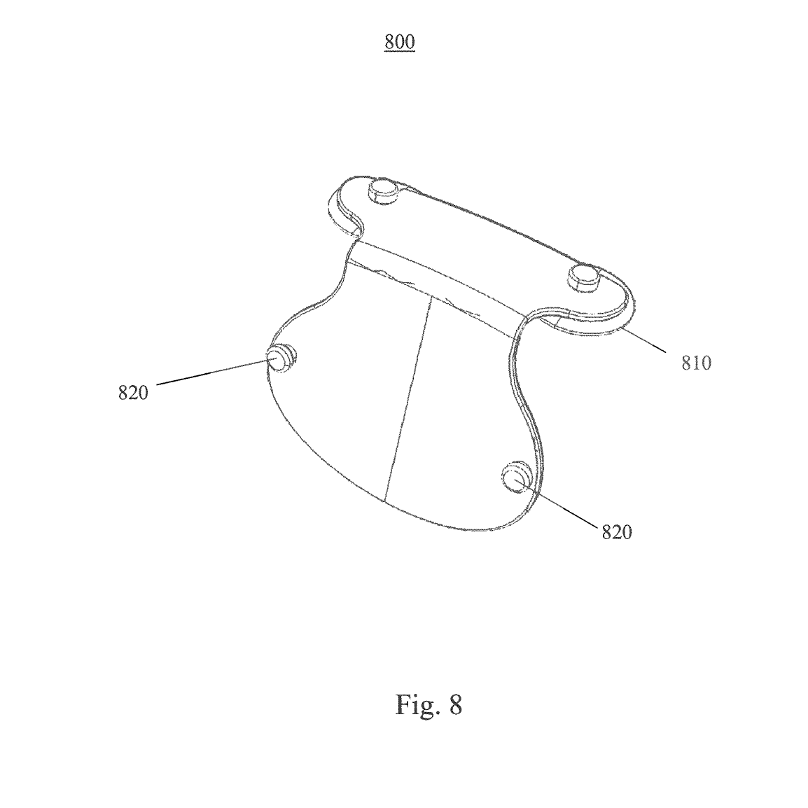

With reference to FIG. 8, shown is a close-up view of suction cup bracket component 800. The suction cup bracket component 800 secures to rear housing component 400 (not shown) using two protrusions 820 extending from suction cup bracket component 800 such that the protrusions 820 fit into the cutouts (not shown) in the back of the rear housing component 400 (not shown). Once the protrusions 820 are inserted into the cutouts (not shown), the suction cup bracket component 400 is moved upward relative to the rear housing component 400 to secure the suction cup bracket component 800 to the rear housing component 400. Suction cups 810 are positioned downward in order to secure the assembled illumination device 10 to the top rim of a toilet bowl (not shown).

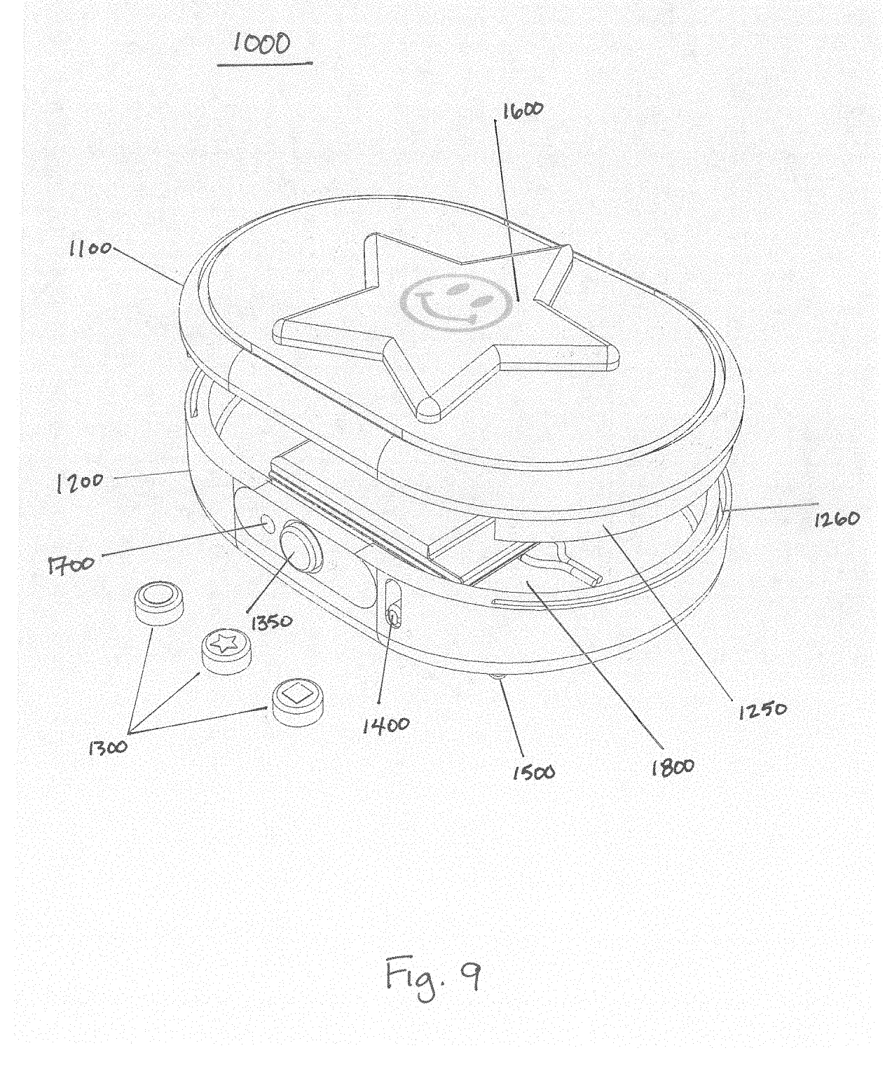

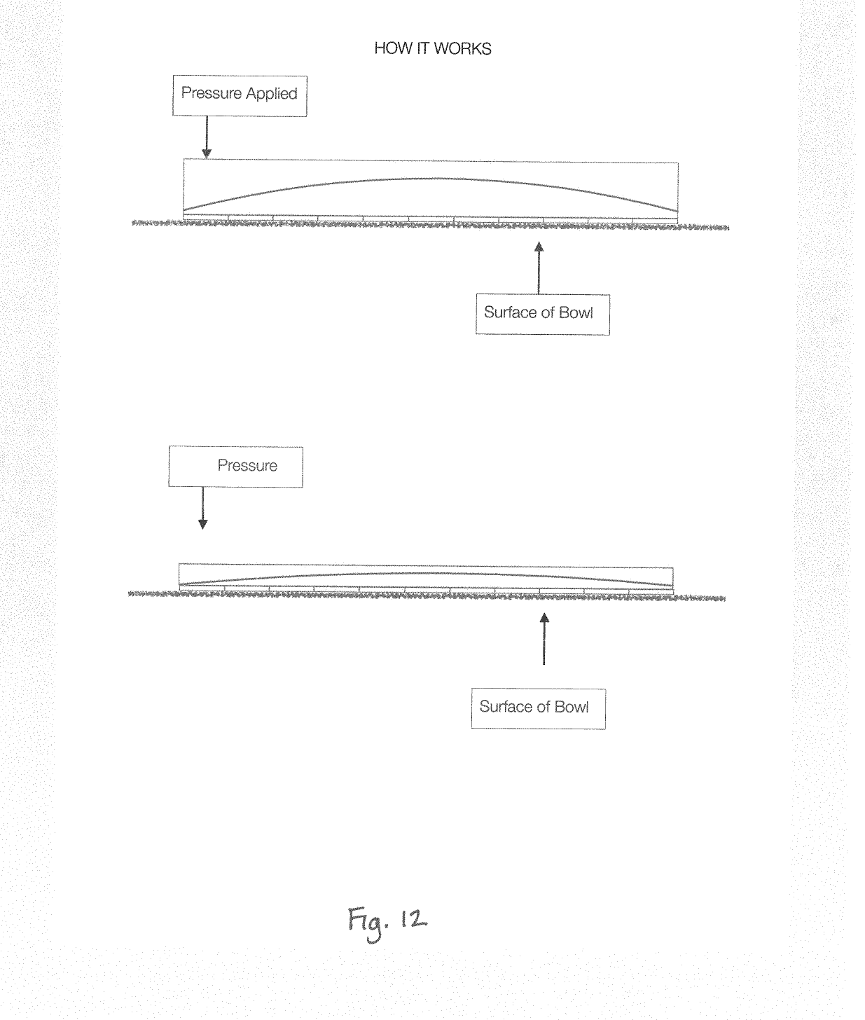

With reference to FIG. 9, shown is a perspective view of the major components of an alternative embodiment of illumination device 1000. The illumination device 1000 is comprised of an upper housing 1100 and a lower housing 1200. The upper housing 1100 is further comprised of an upper snap clip 1250 and a star design 1600. The star design 1600, when activated, illuminates thought a semi-transparent filter. The upper snap clip 1250 securely interacts with a lower snap clip 1260 that is part of the lower housing 1200. The lower housing 1200 is further comprised of an LED light 1350 positioned on one side and an adjustable target switch 1400 adjacent thereto. The bottom surface of the lower housing 1200 is comprised of the suction mount system shown in greater detail in FIG. 12. The adjustable target switch 1400 allows for the adjustment of the direction in which the LED light 1350 is illuminated to allow for movement of the target within the toilet bowl. The LED light 1350 further includes interchangeable caps 1300 which can be removed and/or fixed onto the light to illuminate a number of different shapes onto the surface of the water.

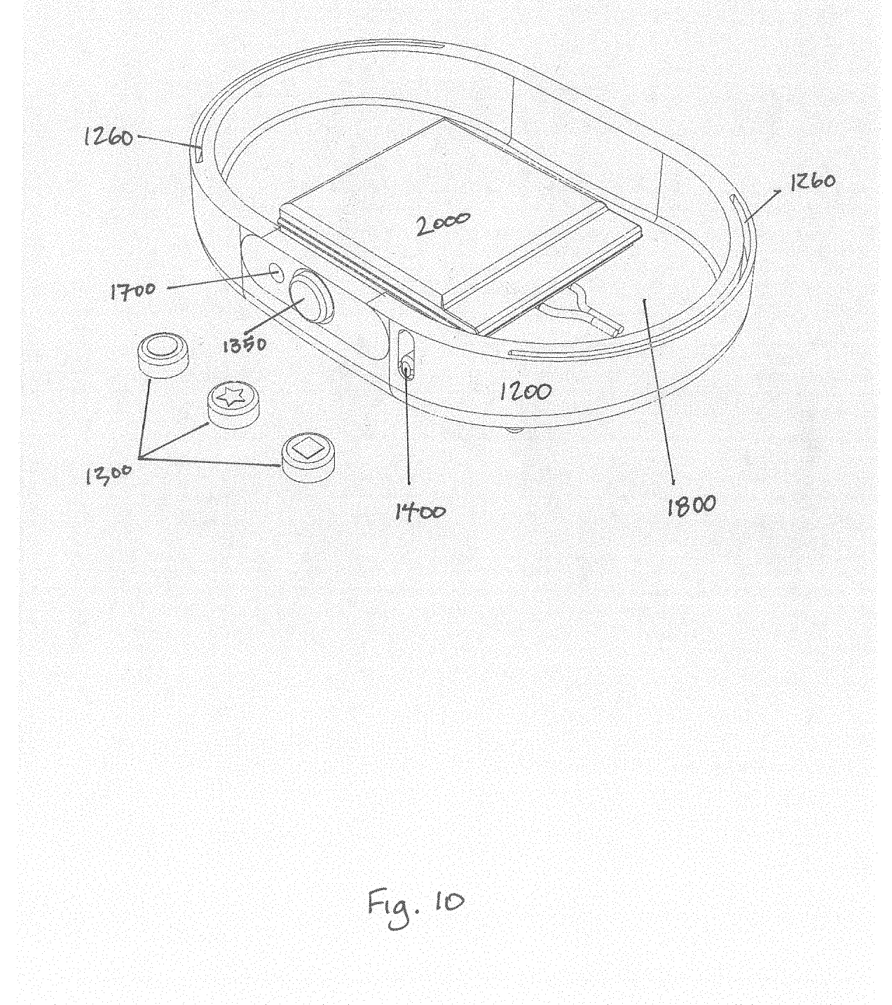

With regard to FIG. 10, shown is the hollow interior 1800 of the lower housing 1200. The lower housing 1200 contains the integrated battery 2000 and electrical components. The position of the lower snap clip 1260 can be seen at each end curved end of the lower housing 1200 corresponding to the upper snap clip on the upper housing (not shown). The lower housing 1200 also contains a motion sensor 1700 adjacent to the LED light 1350.

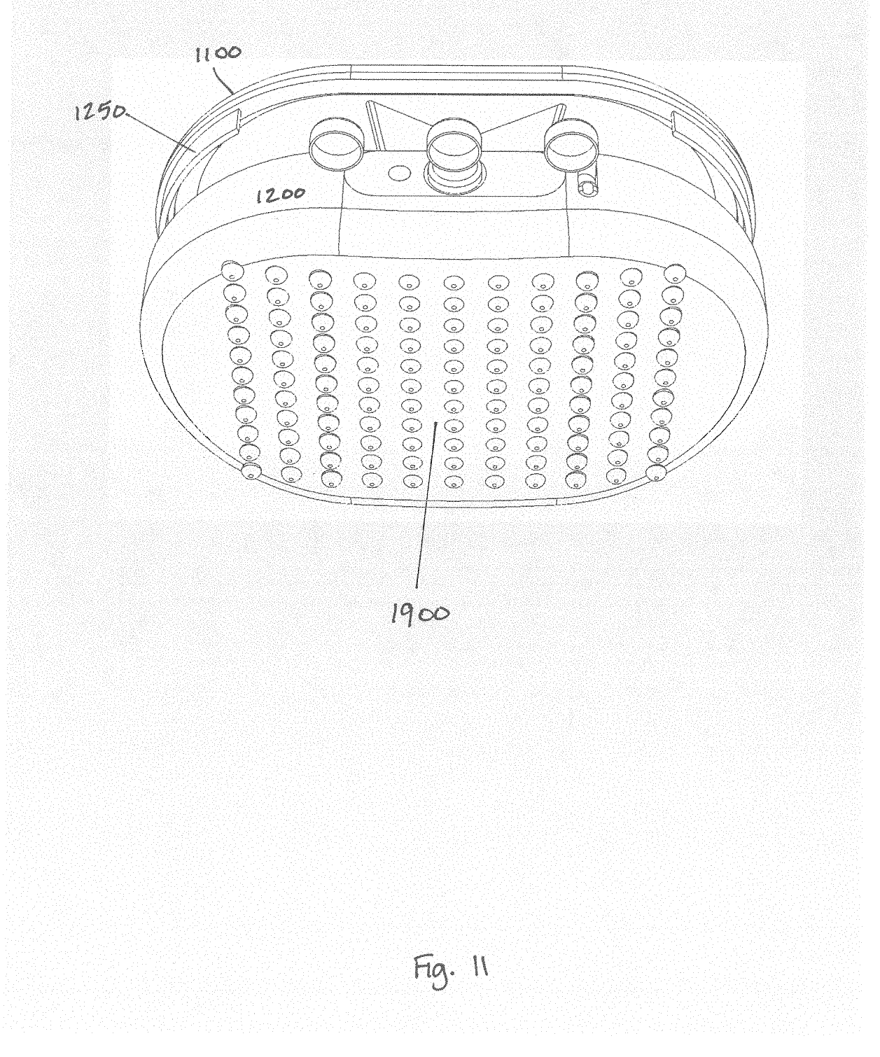

With regard to FIG. 11, shown is the bottom surface of the lower housing 1200 comprising the suction mount system 1900. The suction mount system 1900 is comprised of a plurality of mini suction cups arranged in rows across the entire bottom surface. Alternatively, the suction cups may be arranged in any design which allows for the secure mounting of the illumination device to the inside of a toilet bowl. FIG. 12 illustrates how the curved suction mount system 1900 works. The micro suction cups are positioned against the surface of the toilet bowl. Pressure applied to the illumination device in the direction of the bowl surface causes the expulsion of air from the micro suction cups resulting in the attachment of the suction cups to the bowl surface.

One embodiment of the present invention provides an illumination device comprised of:
an ornamental front housing;
a rear housing;
a suction cup bracket for attaching the illumination device to a toilet;
a battery pack;
a sensor printed circuit board (PCB);
at least one motion sensor; and
at least one LED bulb.

Another embodiment of the present invention provides an illumination device wherein the ornamental front housing is configured in the shape of a star. In a preferred embodiment the ornamental front housing may be configured in the shape of a moon or heart or any appropriate design that appeals to children.

Still another embodiment of the present invention provides an illumination device wherein the front housing and rear housing are manufactured from molded plastic.

Yet another embodiment of the present invention provides an illumination device wherein the battery pack provides power for the sensor PCB which in turn controls the at least one motion detector in the sensor behind the sensor lens resulting in the activation of the LED bulb. In a preferred embodiment, the battery pack may provide power for a plurality of LED lights. In a most preferred embodiment, the battery pack may provide power for music, a plurality of LED bulbs of various colors and/or a lighting sequence.

Still another embodiment of the present invention provides an illumination device wherein the suction cup bracket may be used to attach the illumination device to a toilet by suction cup (as shown), double sided tape or a plastic hook.

A further yet embodiment of the present invention provides an illumination device wherein the light projection from the lens cover swivels to allow the light to fit a variety of toilets wherein the target may be placed according to user's liking.

Still another embodiment of the present invention provides a reusable illumination device wherein the light is activated by movement detected by the at least one sensor making the light hands-free and mess free.

Yet another embodiment of the present invention provides an illumination device for aiding in nighttime bathroom usage by an individual. Additionally, the illumination device may aid in toilet training and aiming for children already toilet trained.

Another embodiment of the present invention provides a fun incentive for children to use the bathroom wherein the illumination device target is moveable to provide variety and encourage practice.

A further embodiment of the present invention provides an illumination device to assist with reducing the stress and fear of nighttime bathroom use by an individual.

In an alternative embodiment, the present invention is an illumination device comprised of:

a shell;

an ambient light sensor;

a PCB board;

a suction system;

an integrated battery; and

an adjustable LED light.

A further embodiment of the present invention provides an illumination device wherein the shell is comprised of an upper housing and a lower housing, the upper housing and the lower housing secured to one another by a snap clip feature.

Yet a further embodiment of the present invention provides an illumination device wherein the lower housing of the shell is further comprised of a unique suction system, the unique suction system providing a simple means for mounting the shell of the illumination device to the inside surface of a toilet bowl.

Still another embodiment of the present invention provides an illumination device wherein the illumination device is further comprised of an adjustable target switch, wherein movement of the adjustable target switch adjusts the LED light and thereby moves the illumination of the LED light on the surface of the water.

A further still embodiment of the present invention provides an illumination device wherein the LED light is compatible with interchangeable caps, the interchangeable caps having various designs to allow for the changing of the shape of the illumination from the LED light.

It will be appreciated that details of the foregoing embodiments, given for purposes of illustration, are not to be construed as limiting the scope of the invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is further defined in the converted utility application and appended claims. Further, it is recognized that many embodiments may be conceived that do not achieve all the advantages of some embodiments, particularly preferred embodiments, yet the absence of a particular advantage shall not be construed to necessarily mean that such an embodiment is outside the scope of the present invention.

We claim:

1. An illumination device for nighttime bathroom usage comprised of:
a shell;
an ambient light sensor;
a PCB board;
a suction system;
an integrated battery; and
an adjustable LED light.

2. The illumination device of claim 1, wherein the shell is comprised of an upper housing and a lower housing.

3. The illumination device of claim 2, wherein the upper housing and the lower housing are secured to one another by a snap clip feature.

4. The illumination device of claim 2, wherein the lower housing of the shell is further comprised of a unique suction system.

5. The illumination device of claim 4, wherein the unique suction system is comprised of a plurality of mini suction cups arranged in rows across the entire bottom surface thereby providing a simple means for mounting the shell of the illumination device to the inside surface of a toilet bowl.

6. The illumination device of claim 2, wherein the lower housing is further comprised of the LED light positioned on one side and an adjustable target switch positioned adjacent thereto.

7. The illumination device of claim 6, wherein the lower housing further includes a motion detector adjacent to the LED light.

8. The illumination device of claim 1, wherein the LED light further includes interchangeable caps which can be removed and/or fixed onto the light to illuminate a plurality of different shapes onto the surface of the water.

9. The illumination device of claim 2, wherein the lower housing is housing.

10. The illumination device of claim 9, wherein the lower housing contains the integrated battery and electrical components.

11. The illumination device of claim 6 wherein the adjustable target switch adjusts the LED light and thereby moves the illumination of the LED light on the surface of the water.

12. The illumination device of claim 11, wherein the upper housing further comprises a design.

13. The illumination device of claim 12, wherein activation of the design results in illumination through a semi-transparent filter.

14. The illumination device of claim 1, wherein the device is water tight.
